(19) United States
(12) Patent Application Publication
(10) Pub. No.: US 2014/0322418 A1
(43) Pub. Date: Oct. 30, 2014

(54) WATER-BATH OVEN, AND A SYSTEM AND METHOD FOR HEATING FOOD

(71) Applicant: Graham COWE, Plymouth, Devon (GB)

(72) Inventor: Graham Cowe, Plymouth (GB)

(21) Appl. No.: 14/360,616

(22) PCT Filed: Dec. 6, 2012
(86) PCT No.: PCT/IB2012/057020

§ 371 Date: May 24, 2014

(30) Foreign Application Priority Data
Dec. 8, 2011 (GB) 1121111.7

(51) Int. Cl. A47J 27/10

(52) U.S. Cl. CPC A47J 27/10
USPC 426/523; 99/403; 99/342; 99/330

(57) ABSTRACT

The present invention relates to improvements for water-bath cooking and heating food. In particular, the present invention provides a new apparatus and method of heating a water-bath oven 1 that is both environmentally friendly and economical. The present invention includes a liquid water circulation system for conveying liquid water from a separate heat source to a heat transfer element 7 comprising a helically coiled pipe 7 in contact with an exterior surface of a cooking vessel 3, to transfer heat from the liquid water within the helically coiled pipe 7 to water and food within the cooking vessel 3.

The present invention relates to water-bath ovens, water-bath oven systems and methods of heating food, and in particular, although not exclusively, relates to water-bath ovens for use on water-borne craft.

Air ovens comprise a cavity in which food can be heated, for the purpose of either cooking or warming to a desired temperature, by the transfer of heat from a heating element, via air, to the food inside the oven. Conventional air ovens are capable of heating food to temperatures of between about 50 degrees centigrade to 250 degrees centigrade.

In contrast, water-bath ovens are at least partially filled with water such that food can be heated, either for the purpose of cooking or warming to a desired temperature, by the transfer of heat from a heating element, via the water, to the food inside. Conventional water-bath ovens are suitable for heating (for example, cooking, warming or re-heating) food sealed in air-tight containers (for instance, plastic bags) at a temperature of between about 40 degrees centigrade and about 100 degrees centigrade. That is, at a temperature at which heat-induced cooking of food occurs (e.g. denaturing of proteins and nucleic acids), yet below the boiling point of water, at a given atmospheric pressure. Typically, water-bath ovens operate at about 60 degrees centigrade; however, most raw food, if vacuum packed (e.g. sous vide) will cook at 55 degrees centigrade, and some will cook at lower temperatures, such as 45 degrees centigrade, or lower. This may act to kill possible pathogens in the food, for instance at temperatures above 51 degrees centigrade. To cook food in water-bath oven requires the temperature to be maintained within a small range. For instance, traditional counter top water ovens with circulating paddles heat to a uniform temperature with less than 0.05 degrees centigrade variation. However, it is known for water ovens to vary in temperature by as much as 2 degrees centigrade. The temperature used depends on the kind of food to be prepared, and the foods' state of preparation before being introduced into the water oven. For instance, the food may be pre-cooked, raw or frozen, and may be egg, fish, meat, vegetables, sweet or savoury puddings, or similar. In addition, the cooking process requires an extended period of time, typically 1 hour, but may be as much as 72 hours. The re-heating of cooked foods process requires less time, for instance 20 minutes at 55 degrees centigrade. The cooking or re-heating time depends on the kind and quantity of food to be prepared and the size and temperature of the water-bath oven.

Water-bath ovens, also known as for example water bath cookers, water ovens or sous-vide cookers, may be used both commercially and in the domestic environment. They may be ideally suited for use in non-static environments such as the marine environment (on board ships, boats, yachts or other water-borne craft) and in motorised caravans or campervans, and/or in any form of non-static vehicle. In particular, other conventional cooking appliances, such as gas ovens, are dangerous to use when a host vehicle is in motion, such as when a yacht is at sea.

Food for use in water-bath oven can be purchased pre-packaged in vacuum packs and/or vacuum-packed pouches. Alternatively, users may vacuum-pack their own food using commercially available equipment or manually with zip lock bags. As a further alternative, food may be placed inside reusable polymer or metal containers, for use within a water-bath oven. These containers may be rigid plastic containers that are, for instance, cylindrical in form.

According to a first aspect of the present invention, there is provided a water-bath oven for heating or cooking food, comprising: a cooking vessel having an internal volume for receiving water and food; a liquid water circulation system for conveying liquid water from a separate heat source; a heat transfer element arranged in fluid communication with the liquid water circulation system to receive the liquid water from the separate heat source, the heat transfer element comprising a helically coiled pipe for carrying the liquid water from the separate heat source, and arranged to coil around the cooking vessel, in contact with an exterior surface of the cooking vessel, to transfer heat from the liquid water from the separate heat source to water and food within the cooking vessel, wherein the heat transfer element is configured to prevent any direct contact between the liquid water within the heat transfer element and an interior of the cooking vessel; and a water flow valve for controlling the flow of the liquid water from the separate heat source to the heat transfer element.

The liquid water within the liquid water circulation system may be termed a working fluid and may have a temperature ranging from 30 degrees centigrade to 90 degrees centigrade. In this way, the separate heat source may heat the working fluid for conveying via a conduit to the heat transfer element. That is, heat can be generated at a remote location and used to heat food in the water-bath oven, thereby allowing the warming, cooking or re-heating of food. In particular, waste heat from other processes/machinery may be recycled, excess heat from other processes/machinery may be used without being wasted, or heat from natural/renewable sources may be used.

The working fluid may be re-used. The water circulation system may form a closed loop and/or closed system in which working fluid may be conserved. The water circulation system may comprise at least one conduit. The water circulation system may be a coolant system, central heating system, ground source heat pump, air source heat pump and/or solar water heating system.

For instance, the separate heat source may be an internal combustion engine. An internal combustion engine generates heat as a by-product of its production of mechanical power. A coolant system may be used to remove waste heat from the engine, by circulating a coolant around the engine and removing it to a heat sink. The coolant may be passed to the heat transfer element of the present invention in order to transfer heat from the coolant to food in the vessel. In other words, the coolant from the engine may be the working fluid. Alternatively, the working fluid and the coolant may not be the same. A heat-exchanger may be provided to pass heat from the coolant to the working fluid. Water used in cooling internal combustion engines commonly used on small water craft, such as yachts, may reach an average temperature of 50 degrees centigrade, ranging from 30 degrees centigrade to 90 degrees centigrade in some circumstances.

Alternatively, the separate heat source may be a central heating system. Excess heat from a central heating system may be used in a similar way to transfer heat from the working fluid to water at least partially filling the cooking vessel. For instance, the flow and return circulation to the radiators from a central heating system can have a closed-loop leading to the heat transfer element.

As a further alternative, the separate heat source may comprise solar water heating panels or air/ground source heat pumps that may be used to warm a working fluid that may then be passed to the heat transfer element.

Prevention of any direct contact between working fluid within the heat transfer element and food within the vessel by the heat transfer element may be due to there being no fluid communication between an interior of the heat transfer element and an exterior of the heat transfer element. The working fluid may circulate in a closed system and/or a closed circuit. Alternatively, the working fluid may be in an open system, yet with no means of fluid communication with the interior of the vessel and/or the exterior of the heat transfer element.

The water-bath oven may be termed a water oven, and the cooking vessel may be configured to be at least partially filled with water. The water-bath oven may be configured to optionally operate as an air oven. The water-bath oven may be arranged to heat food for the purpose of cooking, warming and/or re-heating. The water-bath oven may be configured to heat food sealed in airtight containers, for instance, plastic bags, polymer or metal containers, rigid plastic containers, or similar containers.

According to the above methods, food in the vessel may be heated to somewhere in the range of 0 degrees centigrade to 100 degrees centigrade, and more particularly 40 degrees centigrade to 90 degrees centigrade, for instance, 45 degrees centigrade, 50 degrees centigrade, 55 degrees centigrade, or 60 degrees centigrade.

The liquid water circulation system may be configured only to convey liquid water; that is, it may only convey water when the water is in its liquid state. The liquid water circulation system may be configured alternatively or additionally to convey liquid water mixed with an additional substance, such as anti-freeze. The liquid water circulation system may be configured to convey only liquids, and in particular, liquids selected from: oil, coolant, alcohol, water and/or mixtures thereof. The water-bath oven may be a water-heated water oven.

The cooking vessel may have any shape, configuration and/or dimension. The shape, configuration and/or dimension of the cooking vessel may be in part determined by the separate heat source that is intended for use with the water-bath oven. The cooking vessel may have a height of between 300 mm and 700 mm, in particular 605 mm. The cooking vessel may have a diameter of between 100 mm and 300 mm, in particular 150 mm. The cooking vessel may comprise a tube. The cooking vessel may have a substantially cylindrical shape. The cooking vessel may comprise a substantially curved side wall. The cooking vessel may comprise a base plate. The cooking vessel may comprise an opening at an upper end. The cooking vessel may comprise a flange extending around a periphery of the opening. The cooking vessel may comprise an upstanding wall extending from the flange. The cooking vessel may be formed of stainless steel, although other materials are contemplated. The cooking vessel may be formed from 5 mm stainless steel sheet. The cooking vessel may be formed as a single unit. Alternatively, the cooking vessel may be welded and/or glued together.

The cooking vessel may comprise a drain. The drain may comprise a drain hole of any diameter, in particular 22 mm. The drain hole may be located at a lower end of the vessel. The drain may comprise a drain-off valve. The drain-off valve may be remotely operable from, for instance, a drain control located in a work-surface in which the water-bath oven is set. In this way, water can be drained from the vessel.

The cooking vessel may comprise an overflow. The overflow may comprise an overflow hole of any diameter, in particular 20 mm. The overflow hole may be located in the vicinity of an upper end of the vessel, for instance adjacent the opening or within 10 to 100 mm of the opening, in particular 60 mm.

The cooking vessel may comprise a pressure release valve. In this way, a build-up of pressure within the vessel can be released in a controlled manner, so as not to put undue stress on the vessel.

The heat transfer element may be substantially flexible or substantially rigid. The heat transfer element may be in contact with an exterior surface of the curved side wall. The heat transfer element may be wrapped around the vessel. The heat transfer element may extend the whole way around a periphery of the vessel. The heat transfer element may extend up the entire height of the vessel. Alternatively, the heat transfer element may extend a part of the way up the entire height of the vessel, for instance, the heat transfer element may extend from a lower end of the vessel, and the heat transfer element may extend to half the height of the vessel, or any other height, for instance, 300 mm.

The heat transfer element may be slidably received on the cooking vessel, so that its height relative to the vessel may be adjustable. The heat transfer element may be movably attached to the cooking vessel. For instance, the heat transfer element may be arranged to move up and down the vessel, in one embodiment in a sliding manner. The heat transfer element may fit in a close engagement with the vessel, for instance, for enabling efficient heat transfer. In this way, the heat transfer element may be moved up and down the vessel for adjustment of the level the heat transfer element relative to a part of the heat source, for instance an engine coolant inlet. In this way, in certain cases, the height of the heat transfer element may be chosen to allow a predetermined pressure of coolant within the heat transfer element, without the need to incorporate a pump between the heat transfer element and the separate heat source. For instance, if the heat transfer element is at a level substantially higher than an engine coolant inlet, coolant may not flow through the heat transfer element without assistance. The heat transfer element may be configured for fitting to the vessel after the vessel has been mounted into a work surface. Alternatively, or additionally, the heat transfer element may be configured to be fitted to the vessel before the vessel has been mounted into a work surface.

The liquid water circulation system may comprise at least one conduit that may be a feed pipe, tube and/or passage, and may be suitable for conveying working fluid. The heat transfer element may be in fluid communication with the feed pipe and/or a return pipe. The heat transfer element may have a first end and a second end, and be configured to connect to the feed pipe at the first end and/or to the return pipe at the second end. The first end may be lower than the second end. The second end may be lower than the first end.

The return pipe may be lower than a pressurised water inlet of a cooling system. The return pipe may be lower than the cool water top-up level of a cooling system.

The water-bath oven may further comprise at least one electrical heater for heating the interior of the cooking vessel and/or the working fluid. The electrical heater may be suitable for use as an immersion heater and/or a radiative/convective air heater. The electrical heater may be an immersion heater. The electrical heater may be located within the vessel. Alternatively, the electrical heater may be located outside and/or adjacent the vessel. The electrical heater may be located internally of the conduit and/or heat transfer element to heat the working fluid. The electrical heater may be located externally and/or adjacent the conduit and/or heat transfer element to heat the working fluid. The electrical heater may be operable via a manually operable heater switch located on a work-surface in which the water-bath oven is set. In this way, food in the vessel may be heated without need for the separate heat source to be heating working fluid. In this way, the water-bath oven may operate at a temperature of up to 200 degrees centigrade. The water-bath oven may operate at a temperature of between about 50 degrees centigrade and 250 degrees centigrade.

The electrical heater may be powered via a 12V-24V power alternator or 12V-24V DC inverter. The electrical heater may have a power of 200 W, or between 200 W and 500 W. The electrical heater may be powered by a wind turbine or photovoltaic solar panels. The electrical heater may be powered via a 110/240V supply. The electrical heater may have a power of 2-3 kW, preferably 2.7 kW. The electrical heater may be made from stainless steel, although other materials are contemplated.

The water-bath oven may further comprise a lid. The lid may be removably attachable to the vessel. The lid may be configured for sealing the opening at the upper end of the vessel. The lid may be configured to form a water-tight seal with the vessel. The lid may be configured to form an air-tight seal with the vessel. The lid and vessel may be configured to maintain a pressure within the vessel exceeding 1 atmospheric pressure and/or ambient pressure. In one embodiment, the water-bath oven may be, and/or function as, a pressure cooker. The lid may be configured for resting on the flange. The lid may be configured for residing in a region defined by the upstanding wall. The lid may be configured to be removably insertable into the region defined by the upstanding wall. The lid may be configured for a flush-fit with the upstanding wall. The lid may comprise a cap portion for covering the opening. The cap portion may be formed of stainless steel, although other materials are contemplated. The cap portion may be formed of 5 mm stainless steel sheet. The lid may comprise a handle. The handle may be formed from stainless steel, although other materials are contemplated. The handle may be formed of 5 mm stainless steel sheet. The lid may comprise an insulating portion between the cap portion and the handle. The insulating portion may be rigid insulation. The insulating portion may be 10 mm rigid insulation. The lid may be formed as a single unit. Alternatively, the lid may be welded and/or glued together.

The water-bath oven may further comprise insulation. The insulation may be removable. The insulation may be compressible and/or flexible. In this way, the heat transfer element may be movable with respect to the cooking vessel, even when the insulation is located adjacent the heat transfer element and the cooking vessel and/or surrounds the heat transfer element and the cooking vessel. The insulation may surround the vessel and the heat transfer element. In this way, heat may pass between the heat transfer element and the vessel, without substantial loss to the external environment. The insulation may provide a more uniform temperature within the vessel than a traditional water oven. An additional effect of the insulation is to allow the cooking vessel to act as a cool-box, if working fluid is not conveyed to the heat transfer element or if cold working fluid is conveyed to the heat transfer element.

Hot water may be retained for further use within the vessel. The insulation and the mass of water within the vessel retain a considerable amount of heat. For instance, an cooking vessel, heated to 70 degrees centigrade and then left for 12 hours at an ambient temperature outside the cooking vessel of 16 degrees centigrade may be measured at 40 degrees centigrade. In this way, the water may be re-used. The water in the vessel may be re-heated to 55 degrees centigrade by a separate heat source. For instance, a separate heat source in the form of a central heating system may be used with a 200 Watt immersion to reheat the water within the vessel in 30 minutes. In one arrangement, a water-borne craft owner may decide to pre-heat (or ‘charge up’) the cooking vessel to its highest temperature using a mains supply before leaving port. Stale water replacement could be carried out at the end of each trip.

The water-bath oven may further comprise a condenser. The condenser may surround the vessel and the heat transfer element. The condenser may surround the vessel, the heat transfer element and the insulation. The condenser may be a condensing cylinder. The condenser may collect waste water. The condenser may collect waste water from the overflow. The condenser may collect waste water from the drain. The condenser may collect waste water from water vapour condensing inside the condenser.

The water-bath oven may further comprise a mesh or rack, disposed within the vessel. The mesh may extend substantially horizontally across the vessel. In this way, food may be placed on the mesh so as to avoid contact with a lower end of the vessel. In particular, food may be placed on the mesh so as to avoid contact with an electrical heater disposed at a lower end of the vessel.

The water-bath oven may further comprise a heat-exchanger (known in the art as a ‘clarifier’) disposed between the separate heat source and the heat transfer element.

For example, a coolant fluid system may remove heat from the separate heat source and transfer it to the heat-exchanger via coolant fluid. The heat-exchanger may transfer heat from the coolant fluid to the working fluid. In some embodiments, the separate heat source may comprise the coolant fluid system.

The water-bath oven may further comprise a pump disposed between the separate heat source and the heat transfer element. In this way, the water-bath oven may be placed at a level higher than a coolant fluid inlet for the coolant fluid system. For instance, an engine that is water-cooled may have a water inlet at a first level, and the water-bath oven of the present invention may have a heat transfer element at a second higher level. A pump may be used to lift the water above the first level (i.e. the level of the water inlet) to reach the heat transfer element. Alternatively, where a closed water-cooled coolant fluid system is used to cool the engine, a heat-exchanger may be provided at a third level, at or below the first level. A pump may be provided to circulate working fluid between the clarifier/heat-exchanger and the heat transfer element.

The water-bath oven may further comprise an activation valve for controlling the flow of the working fluid from the separate heat source to the heat transfer element. The activation valve may be actuated remotely and may control whether fluid flows from the separate heat source to the heat transfer element. The activation valve may control the amount of fluid flow from the separate heat source to the heat transfer element on a sliding or incremental scale.

The water-bath oven may further comprise a temperature sensor, for determining a temperature. The temperature sensor may be configured to detect a temperature of the working fluid. The temperature sensor may be configured to detect a temperature of water within the vessel.

The water-bath oven may further comprise a water flow controller for controlling the water flow valve in response to a temperature detected by the temperature sensor. In this way, the temperature within the vessel can be tightly controlled. The water-bath oven may further comprise a thermostat controller for controlling the electrical heater in response to a temperature detected by the temperature sensor. The thermostat or water flow controller may control the electrical heater in response to water in the vessel having a temperature below a first threshold value and/or above a second threshold value. In this way, the temperature within the vessel can be raised above the temperature of the working fluid. The thermostat and water flow controller may be functionally comprised within a single controller.

The water-bath oven may further comprise temperature control means for controlling the thermostat and/or water flow controller. The temperature control means may comprise a control interface located on a work-surface in which the water-bath oven is set. The temperature control means may be operable by a user to vary a desired heating temperature of the water-bath oven. In this way, the heating temperature may be selected by a user to suit various types of food to be cooked, warmed and/or re-heated. In this way, an operator may determine the temperature to which food is to be heated.

The water flow valve may comprise an activation valve and a control valve.

The water-bath oven may further comprise a mesh holding plate or holding rack, disposed within the vessel, for holding food below a surface of water within the vessel. The mesh holding plate may extend substantially horizontally across the vessel. In this way, food will not float to the surface of the water within the vessel, while still allowing convection to occur in water within the vessel.

The water-bath oven may further comprise a filling tap, for the supply of water into the vessel.

The water-bath oven may further comprise a pouch temperature probe, for determining the temperature of food within a container and/or pouch present within the vessel.

Unlike other forms of oven, a gimbal may not be required in marine environments, as any rocking motion of the boat may provide the necessary stirring effect for homogenous temperature distribution within the vessel. However, in non-marine environments, the water-bath oven may comprise a movement paddle to provide a stirring effect of the fluid within the vessel. The movement paddle may be manually operated, or automatic. The movement paddle may be located at a lower end of the vessel.

According to a second aspect of the present invention, there is provided a water-bath cooking system for heating or cooking food, comprising a water-bath oven and a separate heat source.

According to a third aspect of the present invention, there is provided a water-bath cooking system for heating or cooking food, comprising at least two water-bath ovens, wherein the heat transfer elements of each water-bath oven are connected together in parallel or series.

According to a fourth aspect of the present invention, there is provided a method of heating food, comprising the steps of: providing a water-bath oven; placing food within the vessel; and conveying working fluid (e.g. liquid water) from a separate heat source to the heat transfer element via the liquid water circulation system.

According to a fifth aspect of the present invention, there is provided a water-borne craft including: an internal combustion engine; and a water-bath oven.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

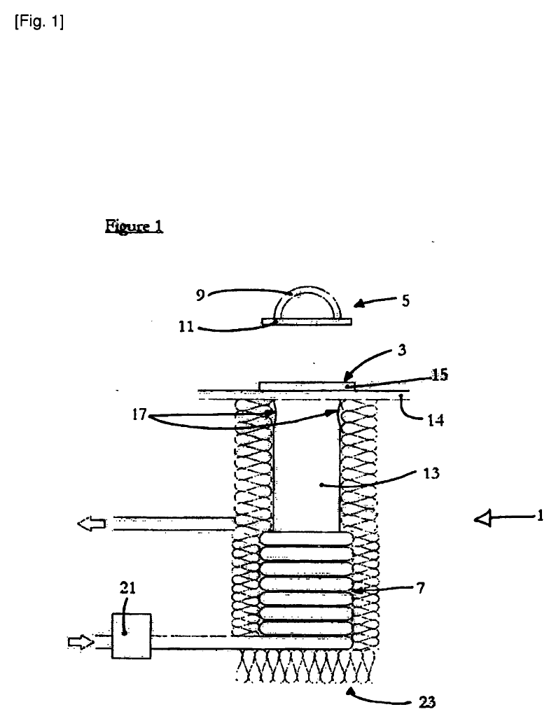

FIG. 1 shows a partially cut-away side plan view of part of a water-bath oven according to an embodiment of the present invention.

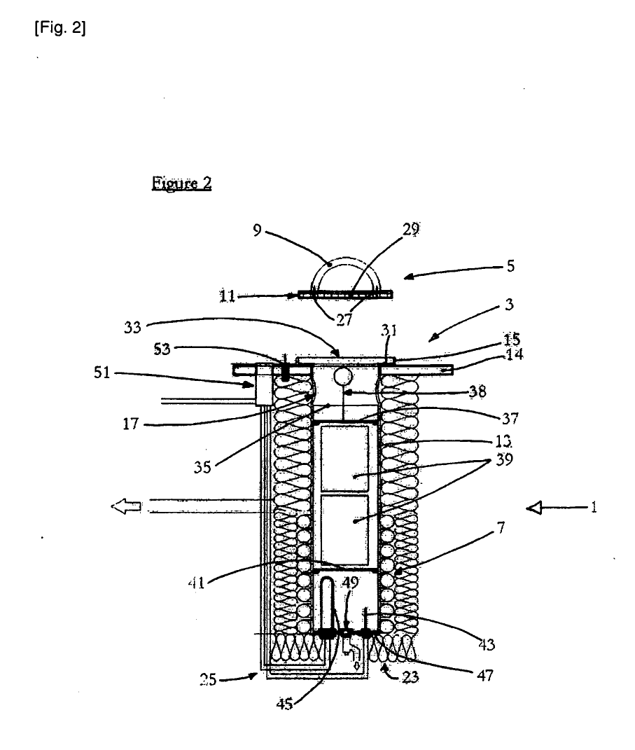

FIG. 2 shows cutaway of the part of the water-bath oven shown in FIG. 1.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical, fluid or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may refer to different embodiments. Furthermore, the particular features, structures or characteristics of any embodiment or aspect of the invention may be combined in any suitable manner, as would be apparent to one of ordinary skill in the art from this disclosure, in one or more embodiments.

Similarly, it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may, in some embodiments, mean only one. The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

FIG. 1 shows part of a water-bath oven 1 according to an embodiment of the present invention having a vessel 3, a lid 5 and a heat transfer element 7.

The vessel 3 comprises a cylinder having diameter 150 mm and height 605 mm, and is constructed from 5 mm stainless steel plate. The vessel 3 comprises a curved side wall 13, and an opening (not shown) at an upper end extending substantially across the full diameter of the cylinder. An upstanding wall 15 of height 20 mm extends from a flange (not shown) that extends around a periphery of the opening. The vessel 3 is mounted in a work-surface 14. The lower end of the cylinder is sealed with a base plate (not shown). Two overflow holes 17 of diameter 20 mm, with their centres spaced 60 mm from the upper end of the cylinder, are located in the curved side wall 13 diametrically opposite one another.

The lid 5 comprises a curved handle 9 attached to a cap portion 11. The cap portion 11 is configured to be removably insertable into a recess formed by the flange and upstanding wall 15, so as to form a water-tight seal.

The heat transfer element 7 comprises a coiled, helical stainless steel pipe configured to carry water from a separate heat source. In an alternative embodiment, the pipe is copper. The heat transfer element 7 is coiled around the vessel 3 from substantially the lower end to substantially half the height of the vessel 3 (approximately 300 mm).

The vessel 3 and heat transfer element 7 are surrounded by insulation 23, which has been shown partially cut-away for clarity. The insulation is shown as compressible and flexible. In this way, the heat transfer element may be movable with respect to the cooking vessel.

The lower end of the heat transfer element is in fluid communication with a 12 volt motorised activation valve 21, such that flow of the working fluid can be controlled.

FIG. 2 shows a cut-away of the view shown in FIG. 1, through the central axis of the cylinder.

The cap portion 11 of the lid 5 is coupled to the handle 9 by means of two screws 27, although other fixing means are envisaged. In between cap portion 11 and the handle 9 is a 10 mm slab of rigid insulation 29.

Flange 31 is shown extending around the periphery of the opening 33, with upstanding wall 15 extending therefrom.

The vessel has been partially filled with water up to a level 35 approximately 25 mm below the centres of the overflow holes 17.

A mesh holding plate 37 extends across substantially the entire width of the vessel 3 and prevents containers 39 from floating to the surface 35 of the water, and comprises a handle 38 for removing the holding plate 37 without contact with the water. A mesh 41 also extends substantially across the entire width of the vessel 3 and prevents the containers 39 from sinking lower than approximately 180 mm from the lower end of the vessel 3.

Occupying the region of the vessel 3, below the mesh 41, are a temperature sensor 43 and an electrical immersion heating element 45. The temperature sensor 43 and the electrical heating element 45 are electrically coupled to one another by the wires 25. The wires 25 have been shown schematically for clarity.

A base plate 47, constructed from 5 mm stainless steel plate, seals the lower end of the vessel 3, and is welded to the curved side wall 13. In the centre of the baseplate 47 is a 22 mm diameter drain hole 49.

In use the vessel 3 may be filled with water up to the level 35. The containers 39 may be placed into the water, above the mesh 41. The mesh holding plate 37 is then secured into place below the water level 35. The motorised activation valve 21 may be actuated to allow water to flow from the separate heat source to the heat transfer element 7. Heat from the water in the heat transfer element 7 passes through the curved side wall 13 into the water inside the vessel 3. The water inside the vessel 3 increases in temperature, thereby heating the food in the containers 39. Heat is prevented from being lost by the insulation 23.

The temperature sensor 43 detects the temperature of the water in the vessel and a digital thermostat controller 51 determines whether to actuate the immersion heater 45 and/or the motorised activation valve 21, based on the state of an on/off switch 53. Signals are sent to the immersion heater 45 and/or the motorised activation valve 21 via wires 25 from the controller 51.

If the vessel 3 is overfilled, water can leave the vessel 3 through the overflow holes 17. Similarly, if there is a pressure increase within the vessel 3, overflow holes 17 act to release the pressure, rather than an undesirable pressure being placed on the lid 5.

The drain hole 49 can be used to empty for cleaning and replacing the existing water from the vessel 1, especially if spillage of food into the cylinder happens, say from a badly sealed pouch.

1. A water-bath oven for heating or cooking food, comprising:
a cooking vessel having an internal volume for receiving water and food;
a liquid water circulation system for conveying liquid water from a separate heat source;
a heat transfer element arranged in fluid communication with the liquid water circulation system to receive the liquid water from the separate heat source, the heat transfer element comprising a helically coiled pipe for carrying the liquid water from the separate heat source, and arranged to coil around the cooking vessel, in contact with an exterior surface of the cooking vessel, to transfer heat from the liquid water from the separate heat source to water and food within the cooking vessel, wherein the heat transfer element is configured to prevent any direct contact between the liquid water within the heat transfer element and an interior of the cooking vessel; and
a water flow valve for controlling the flow of the liquid water from the separate heat source to the heat transfer element.

2. A water-bath oven according to claim 1, in which the heat transfer element is slidably received on the cooking vessel, so that its height relative to the cooking vessel may be adjustable.

3. A water-bath oven according to claim 1 or claim 2, further comprising at least one electrical heater for heating the interior of the cooking vessel.

4. A water-bath oven according to any preceding claim, further comprising a temperature sensor, for determining a temperature of the interior of the cooking vessel.

5. A water-bath oven according to claim 4, further comprising a water flow controller for controlling the water flow valve in response to a temperature detected by the temperature sensor.

6. A water-bath oven according to any one of claims 4 and 5, when dependent upon claim 5, further comprising a thermostat controller for controlling the electrical heater in response to a temperature detected by the temperature sensor.

7. A water-bath cooking system for heating or cooking food, comprising a water-bath oven according to any preceding claim, and a separate heat source.

8. A water-bath cooking system according to claim 7, in which the separate heat source is an internal combustion engine.

9. A water-bath cooking system for heating or cooking food, comprising at least two water-bath ovens according to any one of claims 1 to 6, wherein the heat transfer elements of each water-bath oven are connected together in parallel or series.

10. A method of heating food, comprising the steps of:
providing a water-bath oven according to any one of claims 1 to 6;
placing food within the cooking vessel; and
conveying liquid water from a separate heat source to the heat transfer element via the liquid water circulation system.

11. A water-borne craft including: an internal combustion engine; and the water-bath oven according to any one of claims 1 to 6.

12. A water-bath oven substantially as hereinbefore described with reference to the accompanying drawings.
